(19) United States
(12) Patent Application Publication
(10) Pub. No.: US 2008/0184283 A1
(43) Pub. Date: Jul. 31, 2008

(54) Remote Console for Central Administration of Usage Credit

(75) Inventors: Michelle Maislen, Woodinville, WA (US); Garrett R. Vargas, Sammamish, WA (US); Curt Andrew Steeb, Redmond, WA (US); Jeffrey Alan Herold, Bellevue, WA (US); Martin H. Hall, Sammamish, WA (US); Isaac P. Ahdout, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/697,354

(22) Filed: Apr. 6, 2007

Related U.S. Application Data
(63) Continuation-in-part of application No. 11/668,444, filed on Jan. 29, 2007.

(51) Int. Cl. H04N 7/16

(52) U.S. Cl. 725/1

(57) ABSTRACT

A management console may be used to monitor available usage on a pay-per-use electronic device, such as a pay-per-use computer. When the management console determines that any of tie monitored electronic devices has reached a trigger level the management console may re-charge the electronic device with value. The value may be taken from a local pool of value stored at the management console or the an add-value transaction may be generated at the management console on behalf of the pay-per-use electronic device. In an Internet cafe or similar environment, the use of the management console shields individual users from usage purchase transactions for individual pay-per-use electronic devices.

### RELATED APPLICATION

This application is a continuation-in-part of U.S. patent application Ser. No. 11/668,444, titled “Capacity on Demand Computer Resources,” filed Jan. 28, 2007.

### BACKGROUND

A pay-per-use device, such as a computer or cellular telephone often allows addition of usage time by purchasing a pre-paid card or adding funds to a debit account. However, in many instances, a user may not be in a position to use all the time purchased and risks losing some of the pre-paid funds. Some environments, such as an Internet cafe, allow a user to buy a block of time from the store operator, who receives payment from the user. To set up such an environment, an intermediary, such as the I-cafe operator or a public resource such as a library, may have to invest a significant amount of funds to establish the facilities for providing use to casual users.

The adoption of a pay-per-use computer, received for free or at a subsidized price, may allow such establishments to offer casual-use computing to constituents while an underwriter recoups the subsidy over time. However, management of a collection of pay-per-use computers may become cumbersome and prone to expiration if the staff does not closely watch each computer's status. Individual monitoring may be difficult or involve actions viewed by users as intrusive. Therefore, management of individual pay-per-use computers or other pay-per-use assets may be difficult.

### SUMMARY

A management console may be used to monitor metering status and act on behalf of individual pay-per-use devices to add usage value, such as time, allowing central management of each device and avoiding time consuming and potentially intrusive individual monitoring. A user interface on the management console may allow monitoring of time for each designated pay-per-use device and may allow alerts to be set for signaling an operator at different points of operation. The management console may allow use of a pool of time that can be locally distributed to individual machines. In another embodiment, the management console may have access to device information allowing the management console to act on behalf of the device when purchasing usage time or updating a subscription.

### BRIEF DESCRIPTION OF THE DRAWINGS

FIG. 1 is a block diagram of system supporting management of pay-per-use computers or computing assets;

FIG. 2 is a simplified and representative block diagram of computer configured to support operation as a pay-per-use computer or management console;

FIG. 3 is a simplified and representative block diagram of a security module such as may be found in a pay-per-use computer or security module;

FIG. 4 is an illustration of a block diagram of a user interface for monitoring pay-per-use computers;

FIG. 5 is an illustration of a user interface for adding value to a management console value pool;

FIG. 6 is an illustration of an alternate user interface for monitoring a pay-per-use computer;

FIG. 7 is an illustration of a user interface for adding value to a pay-per-use computer; and

FIG. 8 is a flow chart representing a method of using a management console for administration of usage value on a pay-per-use computer.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

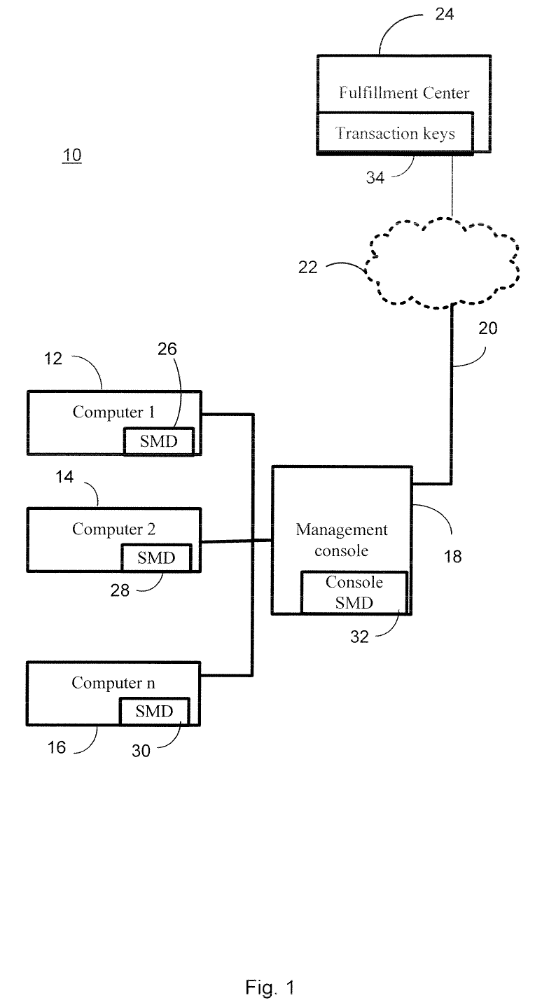

FIG. 1 is a block diagram of a system for managing pay-per-use computers in a networked environment. Such computers may be found in an Internet cafe, a library, or other setting where individuals may use the computers either for a fee, or in exchange for some other consideration, such as a purchase of goods. Pay-per-use computers may be installed by an agreement with a service provider that may lower the initial investment in the computers in exchange for a contract for additional purchases over a period of time. The contract may be implemented in many different forms, for example, a monthly subscription for a number of months or a number of usage minute purchases within a given period of time.

The system 1 0 may include a number of pay-per-use computers, such as a first computer 12, a second computer 14, and a representative last computer 16. The system 110 may also include a management console 18 that an operator can use to oversee operation of the computers 12, 14, 16. The management console 18 may be connected over a local access connection 20 to a wide area network 22, such as the internet, to a fulfillment center 24. The local access connection may be wired or wireless. The fulfillment center 24 may process requests for add value packets and may be connected to financial institutions or other service providers and underwriters (not depicted). The underwriters may provide the computers, the management console, or both, for a subsidized price in exchange for a financial commitment from the operator. The fulfillment center 24 may have cryptographic keys 34 for supporting authentication and value-add transactions with the pay-per-use computers 12, 14. 16 both directly and through the management console 18.

The computers 12, 14, and 16 are shown connected to the wide area network 22 via the management console 18. Other embodiments may use a router (not depicted) in a known configuration to connect each computer 12, 14, 16 and the management console 18 separately to the local access line 20 and thereby to the wide area network 22.

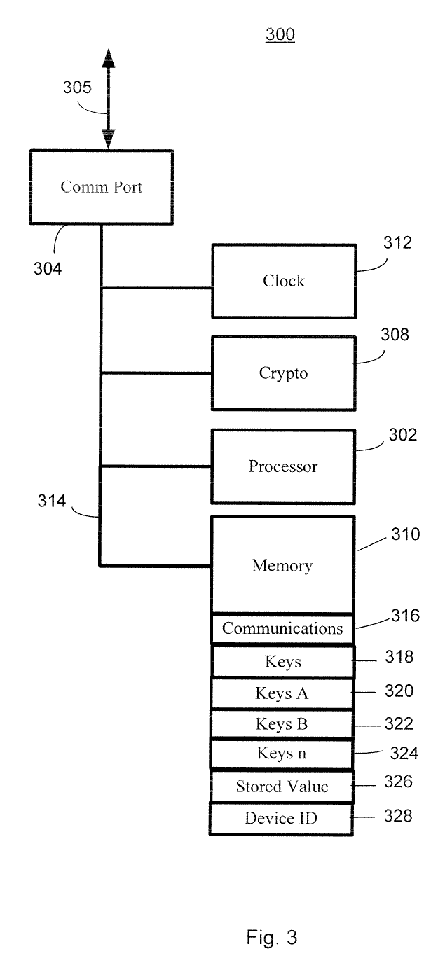

Each computer 12, 14, 16, and the management console 18 may have a respective security module 26, 28, 30, and 32. The security module is discussed in more detail with respect to FIG. 3, but briefly, each security module 26, 28, 30, and the console security module 32 has a processor, a secure memory, and a cryptographic function implemented in hardware or software for supporting metering operations, value add packet processing, and self-sanctioning of pay-per-use computers not in compliance with their contractual terms. The security modules 26, 28, 30 may be identical in construction to the console security module 32 of the management console 18, with a possible difference arising in key content and programming. As discussed in more detail below, the console security module 32 may have additional keys and functions related to administering the pay-per-use computers 12, 14, 16, such as storing bulk value and apportioning it to an individual machine or causing an individual machine to request a value add transaction, as the need arises.

In another embodiment, the computers 12, 14, and 16 may be computing resources that can be turned on and off as peak demand requires additional resources. For example, each computer 12, 14, and 16 may be blade servers that can be activated upon request as long as usage time is available. The usage time may be decremented according to usage, either by processor cycles, pure time, or another metric such as data I/O or disk utilization.

In operation, the pay-per-use computers 12, 14, 16 may be deployed as discussed above, in a public use setting such as an Internet cafe. Such an embodiment is used for illustration, but other embodiments may encompass deployment in settings ranging from a small office/home office to a deployment over a wide geographic area. For example, a business may choose to deploy pay-per-use computers to remote workers but still retain central management of value usage and the value add process. The management console 18 may monitor usage time on each of the deployed pay-per-use computers 12, 14, 16. In one embodiment, a use may check-in and check-out when using a computer 12 and be charged for the amount of value consumed during that usage session. Alternatively, use of the computer 12 may be included with a package including other goods or services, such as a meal or hotel stay.

Initial configuration of a managed system of pay-per-use computers 12, 14, 16 and management console 18 may involve not only the installation of keys binding the pay-per-use computers 12, 14, 16 to the fulfillment center 24, but also installation of keys that bind the pay-per-use computers 12, 14, 16 to the management console 18 so that requests for status and value-add packets may be exchanged between these system elements. Additionally, software or firmware in both the pay-per-use computers 12, 14, 16 and the management console 18 may be installed or activated that supports the additional status and value-add functions associated with the managed environment.

Several different instantiations of value management and recharging are discussed below to illustrate a few of the possible variations. The console security module 32 may request and store usage value, such as minutes, for each of the deployed pay-per-use computers 12, 14, 16. In this embodiment, a security module 26 may establish a secure connection with console security module 32 and consume value packets directly from a secure memory of the console security module 32. When usage value reaches a low limit, the management console 18, through the console security module 32 may purchase more time from the fulfillment center 24.

In another embodiment, each security module 26, 28, 30 may store usage of value for its own respective pay-per-use computer 12, 14, 16. As opposed to a stand-alone pay-per-use computer, a security module 26 may include computer executable instructions to respond to a request from the management console 18 for status information about usage value remaining for the security module's corresponding computer 12. When usage value on a computer, such as computer 12, reaches a critical level, the management console l 8 may act to recharge the usage value on the computer 12, according to computer-executable instructions stored in the management console 18.

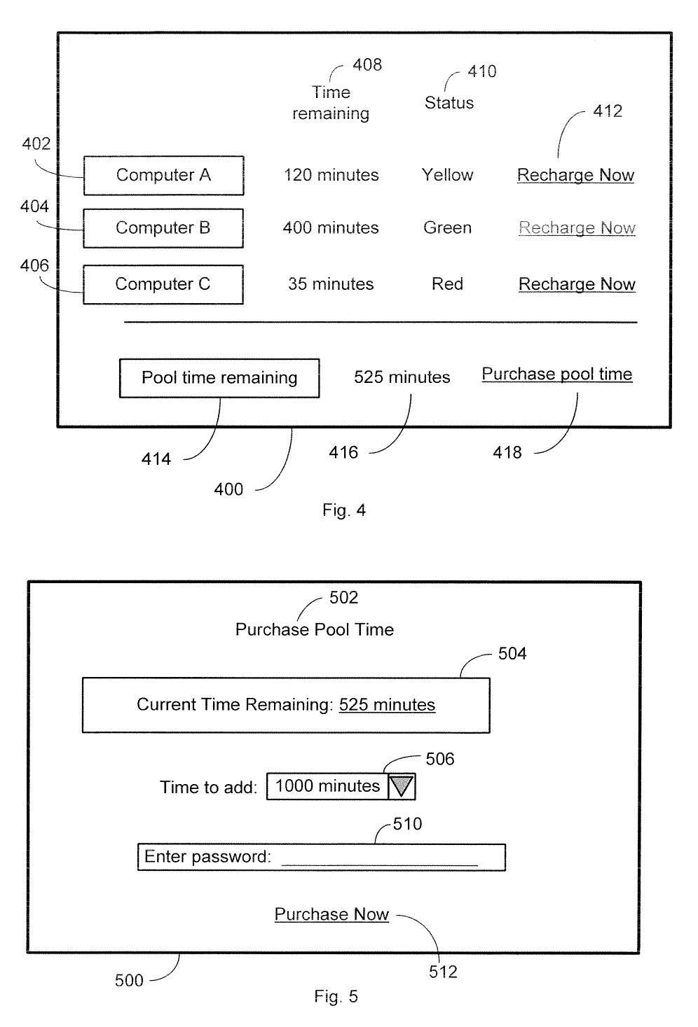

Referring briefly to FIGS. 4-7 exemplary user interface screens that may appear on the management console l 8 are discussed and described. FIG. 4 depicts an exemplary user interface 400 that may be used on a management console, such as management console 18, to monitor and replenish usage value to managed computers, such as computers 12, 14, 16 of FIG. 1. An identifier 402, 404, 406 for each computer is shown on the left of FIG. 4. A value column 408 showing usage value in minutes may be followed by a status column 410 showing the state of each computer. The state may be determined by pre-defined or administrator-settable trigger levels. In this exemplary embodiment, more that 200 minutes may be green, less than 200 may be yellow, and less than 50 may be red. A link column 412 may allow the administrator to move to another screen that allows addition of value to the selected computer. The link for Computer B 404 is shown grayed out, indicating that a recharge is not available for that computer, given the green status of the remaining value. This may be implemented to prevent accidental or abusive over-valuing of an account.

When a pool of usage time is kept at the management console 32, a pool value row 414 may indicate remaining time 416 in the pool. A link 418 to purchase more pool time may be activated to add value to the management console pool account.

FIG. 5 shows an exemplary user interface 500 that may be used on a management console, such as management console 18, to add value to a local pool of usage value, for example, responsive to selection of the link 418 of FIG. 4. The user interface 500 may include a description of the transaction 502, a summary of current usage value 504, and a combo-box 506 or the like for selecting the amount of usage value to purchase. The combo-box 506 may include a drop down list of selectable values for purchase. Usage value is shown in time units, but usage values may be in units of currency, tokens, or subscription end dates, as examples. A password field 510 may allow an administrator to enter a password associated with the financial transaction and a selection link 512 may be used to activate the request process.

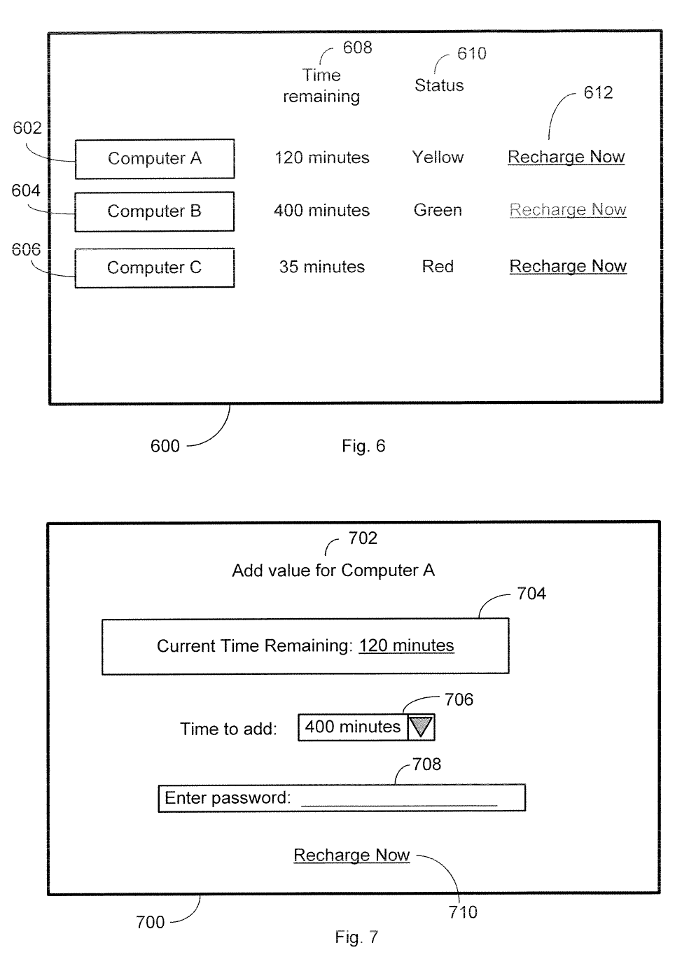

FIG. 6 illustrates an exemplary user interface 600 that may be suitable for use on a management console, such as management console 18. Computer identifiers 602, 604 and 606 may be used to show computers under management. A value column 608 may be used to indicate remaining usage value, such as time, that is available. A status column 610 may allow triggers to be set for easy identification of when action should be taken. The same triggers may also allow automated tasks to be undertaken, from sending an email alert to an operator to automatic re-provisioning of a computer at a low-water mark. A link column 612 may allow an administrator to take action when an individual computer falls below a minimum value.

FIG. 7 shows an exemplary user interface 700 for recharging an individual computer. This user interface 700 may be suitable for use in adding usage value to an individual computer responsive to selection of the exemplary “Recharge Now” links in either FIG. 4 or FIG. 6. That is, the user interface 700 may be agnostic as lo the source of a usage value packet, whether it be from a local pool on the management console 18 or from the fulfillment center 24. A title 702 may identify the computer to which the activity is directed. A status box 704 may show the current time value. A combo-box 706 or equivalent may allow input or selection of an amount of usage value to add. As discussed above, usage value is shown in units of time, but other metrics may be used. A password field 708 may allow qualification of a user for the purpose of performing the transaction. Stronger authentication may be used, for example, using two-factor authentication such as a token and password. The selection link 710 may cause the recharge function to activate. Other user interface screens, for example, for error processing and account selection are not depicted but will be readily obvious to one of ordinary skill in the art.

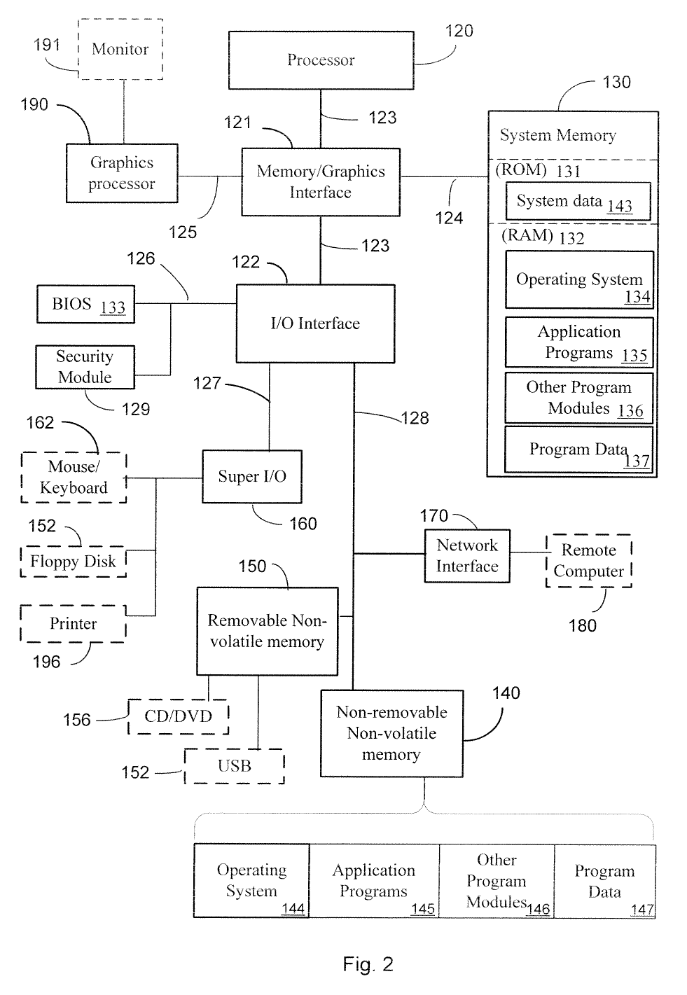

With reference to FIG. 2, an exemplary system for implementing the claimed method and apparatus includes a general purpose computing device in the form of a computer 110. The computer 110 may be suitable for use as either a pay-per-use computer or a management console, with differentiation in the form of computer-executable instructions and cryptographic material, at a minimum, as described below with respect to FIG. 2. Components shown in dashed outline are not technically part of the computer 110, but are used to illustrate the exemplary embodiment of FIG. 2. Components of computer 110 may include, but are not limited to, a processor 120, a system memory 1 30, a memory/graphics interface 12 1, also known as a Northbridge chip, and an I/O interface 122, also known as a Southbridge chip. A memory 130 and a graphics processor 190 may be coupled to the memory/graphics interface 121. A monitor 191 or other graphic output device may be coupled to the graphics processor 190.

A series of system busses may couple various these system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 121 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 2 illustrates operating system 134, application programs 135, other program modules 136, and program n data 137.

The I/O interface 122 may couple the system bus 123 with a number of other busses 126. 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

A security module 129 may also be coupled to the I/O controller 122 via the SPI bus 126. In other embodiments, the security module 129 may be connected via any of the other busses available in the computer 110. The security module 129 is discussed in more detail with respect to FIG. 3. As discussed above, when used in a pay-per-use computer or management console as depicted in FIG. 1, the security module 129 may have a similar component basis when implemented in either the pay-per-use computers 14, 16, 18 or the management console 32 of FIG. 1. Differences may arise in programming and cryptographic key makeup.

A super input/output chip 160 may be used to connect to a number of ‘legacy’ peripherals, such as floppy disk 152, keyboard/mouse 162, and printer 196, as examples. The super I/O chip 122 may be connected to the I/O interface 121 with a low pin count (LPC) bus, in some embodiments. The super I/O chip is widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect—Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile nonvolatile computer storage media. By way of example only, FIG. 2 illustrates a hard disk drive 140 that reads from or writes to non-removable, nonvolatile magnetic media. Removable media, such as a universal serial bus (USB) memory 152 or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 110. In FIG. 2, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a mouse/keyboard 162 or other input device combination. Other input devices (not shown) may include a microphone, joystick, game pad, satellite dish, scanner, or the like. These and other input devices are often connected to the processing unit 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection depicted in FIG. 2 may include a local area network (LAN), a wide area network (WAN), or both, but may also include other networks. Such networking environments are commonplace in offices, enterprise-wide computer networks, intranets and the Internet.

In some embodiments, the network interface may use a modem (not depicted) when a broadband connection is not available or is not used. It will be appreciated that the network connection shown is exemplary and other means of establishing a communications link between the computers may be used.

FIG. 3, a simplified and representative block diagram of a security module 300, the same as or similar to the security module 129 of FIG. 2, is discussed and described. The security module 300 may include a processor 302, a communication port 304, a secure memory 310, a cryptographic function 308 and a clock or timer 32. The processor 302 may be a core processor implemented in a custom or semi-custom design, or may be part of a single-chip computer, or may be one component in a multi-chip module (MCM). Communication port 304 may support more than one communication protocol, for example, peripheral component interconnect (PCI/PCIe), low pin count (LPC), or an serial peripheral interconnect (SPI) protocol. In some embodiments, the security module 300 may support multiple communication protocols at once, allowing data traffic with components on more than one bus.

The secure memory 310 may include key memory 318 storing a device master key, derived or separate keys for communication with a management console, and transitory session keys. When the security module 300 is implemented in a pay-per-use computer, the key memory 318 may store keys for add-value transactions with a fulfillment center, such as fulfillment center 24 of FIG. 1. When implemented in a management console, such as management console 18 of FIG. 1, the security module 300 may include additional keys 320, 322, 324 corresponding to each computer under the control of the management console. Stored value 326 may be used for payment of on-line merchandise or services. In a metered use embodiment, the stored value 326 may represent usage value, such as minutes of computer usage. The stored value 326 may also be associated with subscription terms, such as an expiration date. A device identifier 328 may be securely stored in the memory 310 for use in proof of identity when communicating with an external device.

The cryptographic function 308 may include a random number generator (RNG) 328 and an encryption/decryption function, either hardware or software, for example, a block cipher function. In other embodiments, the cryptographic function 308 may be implemented via a smart chip with full cryptographic capability including public key algorithms, and may communicate with the processor 302 using an ISO 7816 interface.

A clock or timer 312 may be provide tamper resistant time for use in both metering and cryptographic applications, including timeout periods for communications, time stamps for use in secure communications, or in generating a once used in message verification. In metered applications, the clock 312 may provide usage timing or subscription expiration periods. The elements of the security module 300 may be connected by an internal bus 314, chosen from any of several known bus technologies, usually associated with the processor 302 type.

When operated in a pay-per-use computer, such as computer 12 of FIG. 1, the, security module 300 may be used to authenticate a value packet received from the fulfillment center 24 or the management console 18, when pool value is locally distributed. After authentication, usage value carried in the value packet may be stored in the stored value 326 portion of the secure memory 310. The processor 302 may consume the stored value 326 as part of metered use operation. The security module 300 may also be programmed to respond to an authenticated query for usage value received from the management console 18.

When pooled value is stored at the management console 18, the security module 300 may used derived keys for accepting value packets from the management console 18. Alternatively, when pool value is not implemented, the security module 300 may generate a value-add request that is transacted directly from the fulfillment center 24, responsive to a directive from the management console 18. In yet another embodiment, the management console may generate the value-add request on behalf of the pay-per-use computer 12 using credentials stored in the management console 18.

When operated in the management console 18, the security module 300 may implement different functions for requesting status from the pay-per-use computers and for managing and redistributing pool value. A pool value transaction may create a value packet in much the same manner that metering consumes stored value. When value is deducted from the pool, the processor 302 may reduce the pool value by the add-value amount and an add-value packet may be created for distribution to the target pay-per-use computer. The add-value packet may then be processed by the target computer and its stored value amount is increased.

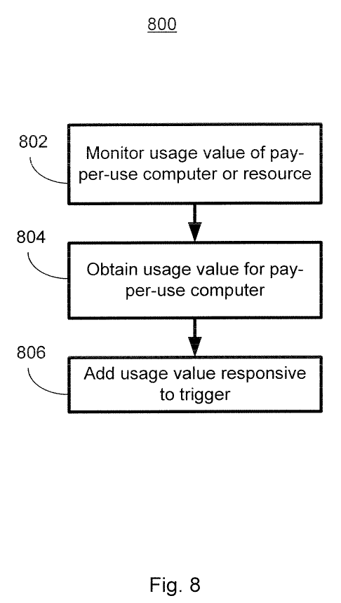

FIG. 8 is a flow chart illustrating a method of performing remote management of one or more pay-per-use computers. At block 802, a management console such as management console 18 of FIG. 1, may monitor usage value of pay-per-use computers, such as pay-per-use computers 12, 14, 16. The usage value data may be forwarded by the pay-per-use computers 12, 14, 16 or may be returned responsive to a poll from the management console 18. A combination of the two may be used, for example the management console 18 may poll on an routine basis, but a pay-per-use computer may send a signal to the management console 18 if a low value or error condition develops.

At block 804, the management console 18 may obtain usage value for the pay-per-use computer when data corresponding to the monitoring causes a trigger event, such as remaining usage value reaching a low value mark. Another trigger event may be when a recurring timed event occurs, e.g. a weekly refill. Alternatively, the trigger may simply be a response to an administrator explicitly requesting more usage value for a particular machine, as may be the case when expecting high volume usage. This may be true whether the pay-per-use computer is in a retail setting, such as an I-café, or in a commercial setting, such as a server farm. In one embodiment, the management console 18 may have a pool of usage value than can be distributed to the managed pay-per-use computers. In another embodiment, the management console 18 may instruct a pay-per-use computer to initiate a transaction directly with a fulfillment center 24. In yet another embodiment, a request may be generated by the pay-per-use computer and sent to the management console 18 for forwarding to the fulfillment center 24. Another implementation may allow the management console 18 to store credentials corresponding to each managed pay-per-use computer 12, 14, 16 that allows the management console 18 to generate add-value request on behalf of the corresponding computer.

At block 806, usage value, such as minutes of use, timed access to computer resource (e.g. additional processor or memory) or a subscription period, may be added to the pay-per-use computer, e.g. computer 12, responsive to the trigger event. Depending on the embodiment for adding value, the usage value may be subtracted from a pool of value stored at the management console 18 and sent to the pay-per-use computer 12, forwarded via the management console 18 from the fulfillment center 24, or sent directly to the pay-per-use computer 12 from the fulfillment center 24. Because value is being transferred over potentially non-secure links, the value packets may be encrypted using a key pair established between the two transacting parties, be it pay-per-use computer 12 to fulfillment center 24, pay-per-use computer 12 to management console 18, or fulfillment center 24 to management console 18.

The use of a management console for administration of pay-per-use computers allows expansion of the pay-per-use concept from individual use to groups of computers. Unlike centralized management of computer software, the centralized use of usage value requires its own set of solutions to issues of reporting, triggering, value management and cryptographic security, as described above. The ability for an I-café operator, small business, or other entity to purchase computers at a subsidized price and repay an underwriter over a period of time may open new opportunities to participate in the global marketplace. Allowing practical management of such pay-peruse resources may allow such an installation to be effectively used and operated.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A management console for operation with a plurality of pay-per-use electronic devices comprising:
a network connection allowing connection with the plurality of pay-per-use electronic devices and an add-value service;
a user interface allowing display of metering status for each of the plurality of pay-per-use electronic devices;
a security module comprising:
a secure memory storing keys and an identifier of the security module;
a tamper-resistant clock;
a cryptographic unit for performing cryptographic functions; and
a processor coupled to the secure memory, the tamper-resistant clock and the cryptographic unit,
a computer-readable medium storing computer-executable instructions; and
a main processor coupled to the network connection, the user interface, the security module, the cryptographic unit, and the computer-readable medium, whereby the processor executes the computer-executable instructions to monitor and update the metering status of each of the plurality of electronic devices.

2. The management console of claim 1, wherein the management console is a computer running a management console software application stored in the computer-readable medium.

3. The management console of claim 1, wherein the secure memory stores first keys for authenticating transactions with a fulfillment center and a set of second keys including a respective second key for authenticating transactions with each of the plurality of pay-per-use electronic devices.

4. The management console of claim 3, wherein the secure memory stores a bulk value packet authenticated by the first keys and distributes a portion of the bulk value to one of the plurality of electronic devices by creating a local value packet signed with the respective second key for the that electronic device.

5. The management console of claim 1, wherein the secure memory stores value packets personalized at a distribution center for transfer to a particular one of the plurality of pay-per-use electronic devices.

6. A method of acquiring usage value for a pay-per-use computer by a management console separate from the pay-per-use computer comprising:
monitoring usage value of the pay-per-use computer at the management console;
obtaining usage value on behalf of the pay-per-use computer;
adding usage value to the pay-per-use computer responsive a trigger event corresponding to monitoring the usage value.

7. The method of claim 6, wherein monitoring usage value comprises monitoring data generated at the pay-per-use computer and sent to the management console via a network connection.

8. The method of claim 6, wherein the trigger event is a low-value limit.

9. The method of claim 6, wherein the trigger event is an administrative action.

10. The method of claim 6, wherein the trigger event is a recurring timed event.

11. The method of claim 6, wherein obtaining usage value comprises purchasing a value block stored at the management console for distribution to the pay-per-use computer.

12. The method of claim 11, wherein adding usage value comprises distributing at least a portion the value block to the pay-per-use computer using a key pair established between the management console and the pay-per-use computer.

13. The method of claim 6, wherein obtaining usage value comprises:
signaling the pay-per-use computer to generate a request for usage value;
receiving the request for usage value from the pay-per-use computer; and
forwarding a request for time from the pay-per-use computer to a fulfillment center.

14. The method of claim 13, wherein adding usage value to the pay-per-use computer responsive to the trigger event comprises receiving a usage value packet from the fulfillment center and forwarding the usage value packet to the pay-per-use computer responsive to the trigger event.

15. The method of claim 6, wherein the usage value is usage time.

16. The method of claim 6, wherein the usage value is a subscription period.

17. The method of claim 6, wherein the usage value is timed access to a pay-per-use computer resource.

18. A system for managing pay-per-use electronic devices comprising:
a pay-per-use computer comprising:
a security module comprising:
cryptographic keys for authenticating transactions;
a stored value corresponding to available usage; and
an executable program responsive to a command requesting stored value metrics and further responsive to a second command for processing an add-value packet;
a management console coupled to the pay-per-use computer through a network comprising:
a console security module comprising:
a cryptographic key corresponding to the pay-per-use computer for use in authenticating transactions with the pay-per-use computer;
a fulfillment center coupled to the management console, the fulfillment center having cryptographic keys associated with the pay-per-use computer and the management console for use in authenticating transactions with each, wherein an add value packet generated at the fulfillment center is encrypted with the management console key and designated for re-encrypting at the management console for delivery to the pay-per-use computer.

19. The system of claim 18, wherein the management console further comprises a user interface and computer-executable instructions for requesting and displaying the stored value corresponding to available usage on the pay-per-use computer.

20. The system of claim 18, wherein the management console further comprises computer-executable instructions for decrypting of the add value packet generated at the fulfillment center and re-encrypting the add value packet using a key shared with the pay-per-use computer.
